(19) United States
(12) Patent Application Publication
(10) Pub. No.: US 2024/0001444 A1
(43) Pub. Date: Jan. 4, 2024

(54) LIQUID METAL EJECTOR LEVEL SENSE SYSTEM AND METHODS THEREOF

(71) Applicant: XEROX CORPORATION, NORWALK, CT (US)

(72) Inventors: Jason M. LeFevre, Penfield, NY (US); Douglas K. Herrmann, Webster, NY (US); Seemit Praharaj, Webster, NY (US)

(73) Assignee: XEROX CORPORATION, NORWALK, CT (US)

(21) Appl. No.: 17/853,676

(22) Filed: Jun. 29, 2022

(51) Int. Cl. B22F 10/34; B22F 10/22; B22F 12/53; B22F 12/55; B22F 12/90; B33Y 10/00; B33Y 30/00; B33Y 70/00

(52) U.S. Cl. CPC B22F 10/34; B22F 10/22; B22F 12/53; B22F 12/55; B22F 12/90; B33Y 10/00; B33Y 30/00; B33Y 70/00; B22F 2301/052

(57) ABSTRACT

A printing system is disclosed, including a metal ejecting apparatus, which may include a structure defining an inner cavity to receive a metal printing material, and a nozzle orifice in connection with the inner cavity and configured to eject one or more droplets of a liquid metal may include the metal printing material. The printing system also includes a first print material feed system configured to supply a first print material into the inner cavity. The printing system also includes a second print material feed system may include a second print material configured to measure a level of metal printing material in the inner cavity, where the second print material is a wire. A method of sensing and controlling level in a metal jetting apparatus is also disclosed.

### TECHNICAL FIELD

The present teachings relate generally to liquid ejectors in drop-on-demand (DOD) printing and, more particularly, to a system for level sensing and methods for use within a liquid metal ejector of a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, particularly one that prints a metal or metal alloy, ejects a small drop of liquid aluminum alloy when a firing pulse is applied. Using this technology, a 3D part can be created from aluminum or another alloy by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

In MHD printing, a liquid metal is jetted out through a nozzle of the 3D printer onto a substrate or onto a previously deposited layer of metal. A printhead used in such a printer is a single-nozzle head and includes several internal components within the head which may need periodic replacement. In some instances, a typical period for nozzle replacement may be an 8-hour interval. During the liquid metal printing process, the aluminum and alloys, and in particular, magnesium containing alloys, can form oxides and silicates during the melting process in the interior of the pump. These oxides and silicates are commonly referred to as dross. The buildup of dross is a function of pump throughput and builds continuously during the print process. In addition to being composed of a combination of aluminum and magnesium oxides and silicates, the dross may also include gas bubbles. Consequently, the density of the dross may be lower than that of the liquid metal printing material and the dross may build at the top of the melt pool, eventually causing issues during printing. Certain DOD printers use, for example, a non-contact red-semiconductor laser sensor, operating at an approximate wavelength of 660 nm, for measuring the melt pool height during printing. This is commonly referred to as a level-sensor. Dross accumulation while printing impacts the ability of the level-sensor to accurately measure the molten metal level of the pump and may lead to prematurely ending the print job. This may also cause the pump to erroneously empty during printing, thereby ruining the part. Dross plugs may also grow within the pump causing issues with the pump dynamics resulting in poor jet quality and additional print defects, such as the formation of satellite drops during printing. The dross could potentially break apart and a chunk of this oxide falls into the nozzle resulting in a clogged nozzle. When the level sense signal “drops out,” this can cause a catastrophic failure condition, leading to printer shut down, requiring clearing or removal of the dross plug, replacing the print nozzle, and beginning start-up procedures again.

Thus, a method of and apparatus for level sense control in a metal jet printing drop-on-demand or 3D printer is needed to provide longer printing times and higher throughput without interruption from defects or disadvantages associated with dross build-up.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A printing system is disclosed, including a metal ejecting apparatus, which may include a structure defining an inner cavity to receive a metal printing material, and a nozzle orifice in connection with the inner cavity and configured to eject one or more droplets of a liquid metal may include the metal printing material. The printing system also includes a first print material feed system configured to supply a first print material into the inner cavity. The printing system also includes a second print material feed system may include a second print material configured to measure a level of metal printing material in the inner cavity, where the second print material is a wire.

Implementations of the printing system may include a pass-through laser sensor, where the second print material is detected by the pass-through laser sensor. The first print material may include a wire. The first print material and the second print material may include the same composition. The first print material may include aluminum.

A method of sensing and controlling level in a metal jetting apparatus is disclosed. The method of sensing and controlling level in a metal jetting apparatus includes advancing a predetermined feed length of a secondary print material may include a wire into an inner cavity of a metal ejecting apparatus where the predetermined feed length corresponds to a target fill level of the inner cavity of the metal ejecting apparatus. The method also includes detecting a first measurement of an end of the secondary print material. The method of sensing and controlling level in a metal jetting apparatus also includes retracting the secondary print material from the inner cavity of the metal ejecting apparatus. The method also includes detecting a second measurement of an end of the secondary print material. The method also includes comparing the first measurement of an end of the secondary print material to a second measurement of an end of the secondary print material to determine a retracted length.

Implementations of the method of sensing and controlling level in a metal jetting apparatus may include repeating the steps of advancing the predetermined feed length of the secondary print material into the inner cavity of the metal ejecting apparatus, detecting the first measurement of the end of the secondary print material, retracting the secondary print material from the inner cavity of the metal ejecting apparatus, detecting the second measurement of the end of the secondary print material, and comparing the first measurement of the end of the secondary print material to the second measurement of the end of the secondary print material to determine a retracted length. The method of sensing and controlling level in a metal jetting apparatus may include pausing after advancing the predetermined feed length of the secondary print material. The method of sensing and controlling level in a metal jetting apparatus may include waiting a predetermined time prior to advancing the predetermined feed length of the secondary print material. The method of sensing and controlling level in a metal jetting apparatus may include increasing the predetermined feed length of the secondary print material if the retracted length is less than or equal to the predetermined feed length of the secondary print material. The method of sensing and controlling level in a metal jetting apparatus may include decreasing the predetermined feed length of the secondary print material is greater than the retracted length of the secondary print material. The method of sensing and controlling level in a metal jetting apparatus may include adjusting a target fill level of a primary print material in the inner cavity of the metal ejecting apparatus. The target fill level of the primary print material can be increased when the predetermined feed length of the secondary print material is less than the retracted length of the secondary print material. The target fill level of the primary print material can be decreased the predetermined feed length of the secondary print material is greater than the retracted length of the secondary print material. The primary print material and the secondary print material may include the same composition.

Another method of sensing and controlling level in a metal jetting apparatus is disclosed, including advancing a predetermined feed length of a secondary print material may include a wire into an inner cavity of a metal ejecting apparatus at a pixel-based feed rate of a primary print material. The method also includes detecting a first measurement of an end of the secondary print material. The method also includes retracting the secondary print material from the inner cavity of the metal ejecting apparatus. The method also includes detecting a second measurement of an end of the secondary print material. The method also includes comparing the first measurement of an end of the secondary print material to a second measurement of an end of the secondary print material to determine a retracted length.

Implementations of the method of sensing and controlling level in a metal jetting apparatus may include adjusting a fill level of the inner cavity of the metal jetting apparatus. The pixel-based feed rate of the primary print material is increased when the retracted length is greater than the predetermined feed length. The pixel-based feed rate of the primary print material is decreased when the retracted length is less than the predetermined feed length. The primary print material and the secondary print material may include the same composition.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid metal ejector jet of a 3D printer (e.g., a MHD printer and/or multi jet printer), according to an embodiment.

FIG. 2 is a side cross-sectional views of a liquid metal ejector contaminated with dross, according to an embodiment.

FIG. 3 depicts a general schematic of a portion of a printing system including a level sensing and controlling system in a metal jetting apparatus in accordance with the present disclosure.

FIGS. 4A and 4B illustrate a schematic of a portion of a printing system including a level sensing and controlling system in a metal jetting apparatus and a magnification thereof, in accordance with the present disclosure.

FIG. 5 illustrates a schematic of a portion of a printing system including a level sensing and controlling system in a metal jetting apparatus during a step of the level sensing and controlling process, in accordance with the present disclosure.

FIG. 6 illustrates a schematic of a portion of a printing system including a level sensing and controlling system in a metal jetting apparatus during a step of the level sensing and controlling process, in accordance with the present disclosure.

FIG. 7 illustrates a schematic of a portion of a printing system including a level sensing and controlling system in a metal jetting apparatus during a step of the level sensing and controlling process, in accordance with the present disclosure.

FIG. 8 illustrates a schematic of a portion of a printing system including a level sensing and controlling system in a metal jetting apparatus during a final step of the level sensing and controlling process, in accordance with the present disclosure.

FIG. 9 illustrates a flowchart of several operation steps of a level sensing and controlling system in a metal jetting apparatus, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present teachings, examples of which are illustrated in the accompanying drawings. Wherever possible, the same reference numbers will be used throughout the drawings to refer to the same, similar, or like parts.

Certain examples of drop-on-demand printers eject a small drop or droplet of liquid aluminum alloy when a firing pulse is applied. Using this technology, a 3D part can be created from aluminum alloy by ejecting a series of drops which bond together to form a continuous part. The present disclosure includes a print-head used in the printer that is a single-nozzle head which includes some internal components within the head needing periodic replacement. A typical period for nozzle replacement is in 8-hour intervals. During a standard printing process the aluminum and alloys, and in particular magnesium, can form oxides during the melting process on the inlet of the pump, which is commonly referred to as “dross.” The dross builds up in the pump during printing and is a function of metal throughput. The dross is a combination of materials such as aluminum oxide, magnesium oxide, aluminum, gas bubbles, or a combination thereof. Dross builds in the top of the melt pool that resides in the ejector pump and causes issues during printing. Dross accumulation can impact the ability of a laser level sensor that measures the molten metal level of the pump. Erroneous readings from this laser level sensor can cause the pump to empty during printing ruining the part. Most dross related level-sense failures lead to shutting down the machine, requiring a clearing or removal of the dross plug, replacing the print nozzle, and/or beginning start-up again. Under such conditions, printers cannot sustain printing at, for example, max jetting frequency of 400 Hz that provides a total aluminum throughput of two pounds or greater for an 8-hour print interval due to dross build-up.

The present disclosure provides a method and system that uses a secondary wire feed input to the upper pump of an ejector, located adjacent to the primary wire feed input. A secondary wire feed input, using the same alloy as the primary wire feed input, can be used as a method of making a positive assessment of the height of the liquid print material in the pump. This secondary wire feed input measurement can be used periodically to verify the fluid height, for example, on the order of every couple minutes. During the intervals in-between these measurements, the machine can rely on a feed-forward control to regulate input wire to the upper pump based on a known drop usage over that time and average drop mass being output by the ejector. The second wire feed wire feed input can utilize a pass-through laser sensor which can assess or measure the initial “end-point” of the wire before it is fed into the molten pool at the top of the pump, and then also re-assessing the “end-point” of the wire once it has been removed from the upper pump of the ejector. Feeding the wire into the upper pump by a known length and then retracting the wire can enable determination of a known maximum height of the fluid in the pump. It should be noted that for the purposes of the present disclosure the term “wire” can refer to a wire, a rod, a ribbon, or similar extensible structure that is structurally appropriate to provide a physical probe of a level of molten print material in an ejector jet as described herein.

Operating in this manner allows a portion of the secondary wire feed input that enters the molten pool of aluminum to be melted, and the length of the wire will be shortened accordingly. The wire will be melted in the pool regardless of if the wire encounters liquid, dross, or a combination of these two. Upon retracting the wire and recording a measurement of the new length can result in one of two conclusions. In a first case (Case 1), if it is measured that the length of the wire has not changed, it can be determined the fluid is at or below a known maximum level. In a second case (Case 2), if it is measured that the length of the wire retracted in shorter as compared to the original length, the exact height of the fluid is known relative to a datum. By beginning at a nominal length of wire corresponding to a target pump fill level to feed in, and then continuing repeat the process and lengthen the distance until the second case (Case 2) is encountered, the exact height of the molten aluminum in the pump can be determined. Such a level sensing system and methods as described herein provides a system and method that remains insensitive to dross build up in an ejector pump, along with any associated defects.

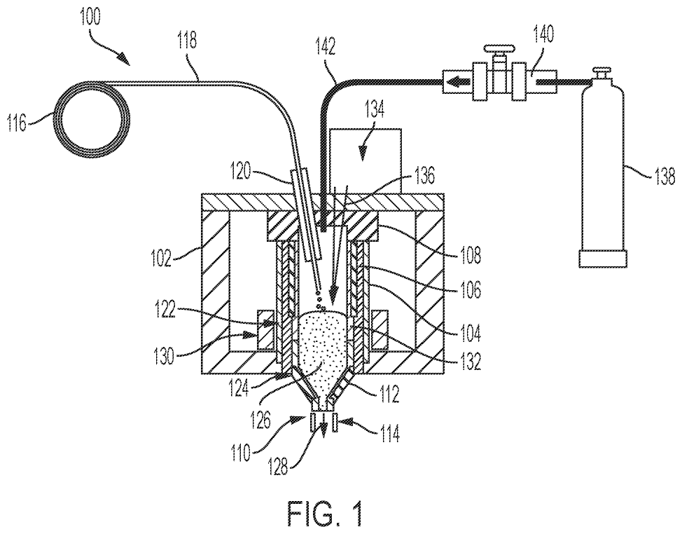

FIG. 1 depicts a schematic cross-sectional view of a single liquid metal ejector jet of a 3D printer (e.g., a MHD printer and/or multi jet printer), according to an embodiment. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity or an inner cavity). A printing material 126 may be introduced into the inner volume 132 of the ejector 104. The printing material 126 may be or include a metal, a metal alloy, or the like. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, also referred to as a nozzle orifice, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate, not shown herein, that is positioned proximate to (e.g., below) the nozzle 110. The ejected drops 128 may land on the substrate and solidify to produce a 3D object. The 3D printer 100 may also include a substrate control motor that is configured to move the substrate while the drops 128 are being jetted through the nozzle 110, or during pauses between when the drops 128 are being jetted through the nozzle 110, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another embodiment, the ejector 104 and/or the nozzle 110 may be also or instead be configured to move in one, two, or three dimensions. In other words, the substrate may be moved under a stationary nozzle 110, or the nozzle 110 may be moved above a stationary substrate. In yet another embodiment, there may be relative rotation between the nozzle 110 and the substrate around one or two additional axes, such that there is four or five axis position control. In certain embodiments, both the nozzle 110 and the substrate may move. For example, the substrate may move in X and Y directions, while the nozzle 110 moves up and/or down in a Y direction.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another embodiment, the gas may be or include nitrogen. The gas may include less than about 10% oxygen, less than about 5% oxygen, or less than about 1% oxygen. In at least one embodiment, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one embodiment, the enclosure 102 may be hermetically sealed. In another embodiment, the enclosure 102 may not be hermetically sealed. In one embodiment, the ejector 104, the heating elements 112, the power source, the coils, the substrate, additional system elements, or a combination thereof may be positioned at least partially within the enclosure 102. In another embodiment, the ejector 104, the heating elements 112, the power source, the coils, the substrate, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design embodiments.

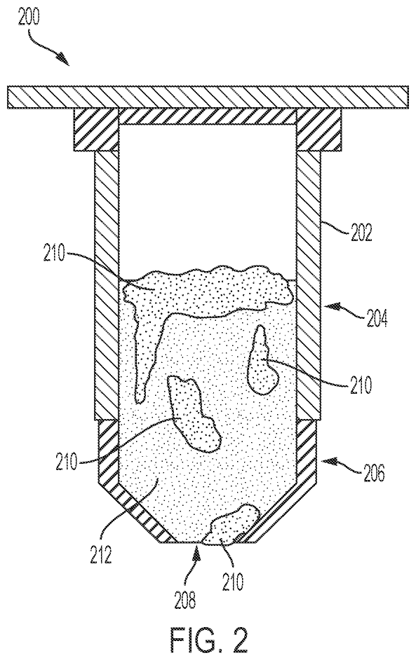

FIG. 2 is a side cross-sectional views of a liquid metal ejector contaminated with dross, according to an embodiment. The ejector 200 is shown, which further defines a cavity or outer wall 202 of the ejector, an upper pump area 204, a lower pump area 206, and an outlet nozzle 208. Within the inner cavity 202 of the ejector 200 is further shown a molten printing material 212 and schematic of dross 210 build-up within and on top of the printing material 212. The dross 210, in certain embodiments, and dependent upon which printing material is used in the printing system, is a combination of aluminum oxides, magnesium oxides, and silicates. The dross 210 may also include gas bubbles. In certain embodiments, the dross 210, may include additional materials or contaminants, such as oxides and silicates of aluminum (Al), calcium (Ca), magnesium (Mg), silicon (Si), iron (Fe), or possibly air bubbles or other contaminants containing sodium (Na), potassium (K), sulfur (S), chlorine (Cl), carbon (C) or combinations thereof, The dross 210 typically builds towards the top of the melt pool that resides near the upper pump area 204 in the ejector 200 and may potentially cause issues during printing. Dross 210 accumulation may potentially impact the ability of the aforementioned level sensor that measures the molten metal level inside the ejector 200. An erroneous signal for the level sensor system can cause the pump to empty during printing, which could result in ruining the part being printed. One or more dross 210 “plugs” may also have a propensity to grow within the pump, which in turn may cause issues with the pump dynamics. Interruptions or issues in pump dynamics may further result in poor jet quality and the formation of satellite drops during printing. A satellite drop may refer to a drop with only a fraction of the volume of the main drop which can be unintentionally formed during the jetting of a main drop. For example, a physical occlusion at the nozzle is one potential cause resulting in the formation of a satellite drop. In certain embodiments or instances, the dross 210 could also potentially break apart, and a portion of this fragmented dross or oxide may fall into the nozzle 208 resulting in a clogged nozzle 208. Any failure arising from the accumulation of dross 210 has the tendency to be catastrophic, which could lead to necessitating a shutdown of the printer, having to clear or remove the dross 210 plug, replacing the print nozzle, beginning start-up again, or combinations thereof. It should be noted that additional features or elements of the printer or ejector system are not depicted in FIG. 2 for purposes of clarity.

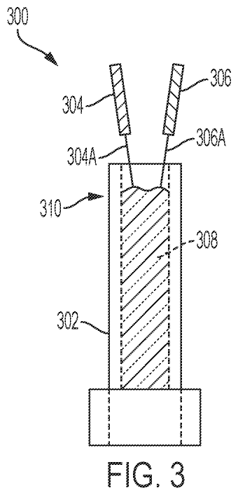

FIG. 3 depicts a general schematic of a portion of a printing system including a level sensing and controlling system in a metal jetting apparatus in accordance with the present disclosure. In FIG. 3, the portion of a level sensing and controlling system 300 includes an upper pump 302 of an ejector for a liquid metal jet printing system. The secondary wire feed system 304 shows an inner cavity or reservoir which retains or holds a molten or liquid printing material 308. The liquid printing material 308 is filled within the upper pump 302 to a fill line which is determined by the system settings, software, a particular print job being executed by the printing system, or a combination thereof. Entering the inner cavity of the upper pump 302 from a primary wire feed system 306 or a primary print material feed system is a primary wire 306A or primary print material, which in exemplary examples has the same composition as the molten or liquid print material 308 already resident in the upper pump 302. Entering the inner cavity of the upper pump 302 from a secondary wire feed system 304 or secondary wire input system is a secondary wire 304A, which in exemplary examples, has the same composition as the primary wire 306A and the molten or liquid print material 308 resident in the upper pump 302 of the portion of a level sensing and controlling system 300. The primary wire 306A may alternately be referred to as a primary or stock printing material. The secondary wire 304A will be used as a way of making a positive assessment of the fill level 310 height of the liquid printing material 308 in the upper pump 302. This secondary wire feed 304 input measurement will be used periodically to verify the fluid fill level 310 height, on the order of two to three minutes in exemplary examples. It should be noted that intervals of the sensing and verification method of the present disclosure may occur on a longer or shorter time scale, which can be dependent on a number of system parameters, such as primary wire feed throughput, job design complexity, or other factors.

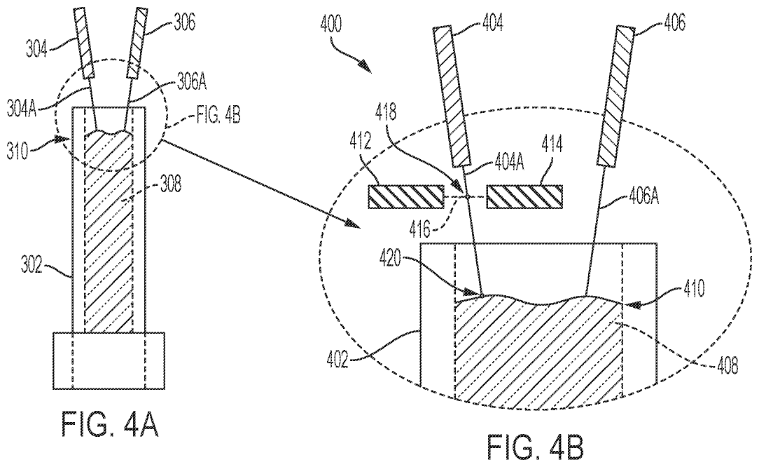

FIGS. 4A and 4B illustrate a schematic of a portion of a printing system including a level sensing and controlling system in a metal jetting apparatus and a magnification thereof, in accordance with the present disclosure. FIGS. 4A and 4B illustrate shows views of the upper pump with a primary and secondary wire feed and the laser sensor used to measure the length of wire during multiple parts of the level sensing process of the present disclosure. FIG. 4A depicts the primary features described in regard to FIG. 3, including an indication of a magnified area, the features of which are described in more detail in regard to FIG. 4B. FIG. 4B depicts a top view of a portion of the level sensing and controlling system 400. Included are the secondary wire feed system 404 and secondary wire 404A and the primary wire feed system 406 or primary printing material feed system; primary wire 406A, both configured to provide either the secondary wire 404A or the primary wire 406A to enter an upper pump 402. Also shown is the molten or liquid print material 408 which is retained with the upper pump 402 to a print material target fill level 410. It should be noted that the secondary wire 404A or the primary wire 406A will both melt when entering the upper pump 402 and contacting the surface of the molten or liquid print material 408 at the print material target fill level 410. The secondary wire feed input 404 will utilize a pass-through laser sensor, including a pass-through sensor laser emitter 412 and a pass-through sensor laser detector 414, which can assess an initial end-point “A” 418 of the secondary wire 404A before it is fed into the molten aluminum liquid print material 408 at the top of the upper pump 402, and then also re-assessing an end-point “B” 420 of the secondary wire 404 once it has been removed from the upper pump 402. During the time in-between these measurements the printer will rely on feed-forward control to regulate the input of the primary wire feed system 406 to feed the primary wire 406A into the upper pump 402 based on a known drop usage over that time and the average drop mass being output by the ejector.

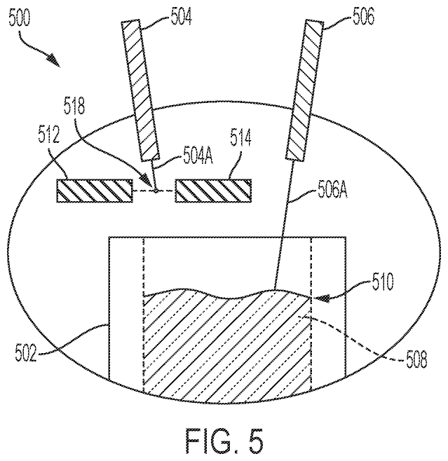

FIG. 5 illustrates a schematic of a portion of a printing system including a level sensing and controlling system in a metal jetting apparatus during a step of the level sensing and controlling process, in accordance with the present disclosure. A view of a portion of a level sensing and controlling system 500 includes a portion of an upper pump 502, a secondary wire feed system 504 having a secondary wire 504A and a primary wire feed system 506 or primary printing material feed system having a primary wire 506A. FIG. 5 illustrates an initial step in the process described herein, which is to establish and determine the current “end” point of the wire, or wire point “B” 520. An algorithm will use input from the secondary wire feed 504 motor & encoder to determine the amount of secondary wire 504A that has been fed from the secondary wire feed system 504 relative to this point “B” 520. The secondary wire 504A will continue to be fed towards the upper pump 502, until a laser 516 emitted from a pass-through sensor laser emitter 512 towards a pass-through sensor laser detector 514 is broken by the continued feeding of the secondary wire 504A. Feeding the secondary wire 504A into the upper pump 502 a known length and then retracting it will reveal a known “maximum” height of the fluid in the pump, which is by the print material target fill level 510. This is because any portion of the secondary wire feed 504 input that enters the molten pool or liquid print material 508 will be melted, and the length of the wire will be shortened accordingly. The secondary wire 504A will be melted in the pool of liquid print material 508 if the wire encounters liquid aluminum, dross, or a combination of these two, a condition which is illustrated in FIG. 2. The retraction of the secondary wire 504A and recording of a measurement of the new length can result in one of two conclusions. A first case (case 1): If it is found that the length of the secondary wire 504A has not changed it can be determined that the fluid is at or below a known “maximum” level; or a second case (case 2): If it is found that the length of the secondary wire 504A returns shorter as compared to its original length, it can be determined that the exact height of the fluid is known relative to a datum, i.e. the laser sensor.

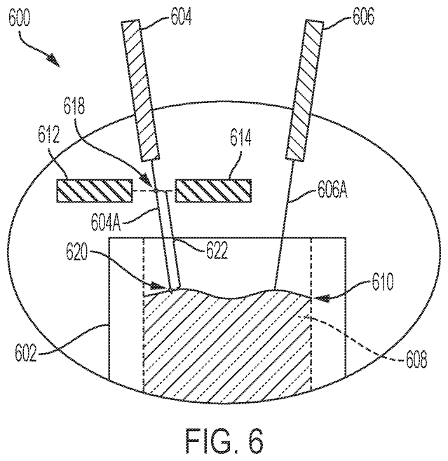

FIG. 6 illustrates a schematic of a portion of a printing system including a level sensing and controlling system in a metal jetting apparatus during a step of the level sensing and controlling process, in accordance with the present disclosure. A view of a portion of a level sensing and controlling system 600 includes a portion of an upper pump 602, a secondary wire feed system 604 having a secondary wire 604A and a primary wire feed system 606 or primary printing material feed system having a primary wire 606A. FIG. 6 illustrates the next step of the process for sensing a level in an ejector jet, which is to feed the secondary wire 604A from the secondary wire feed system 604 in a known length “C” 622, which will place point “B” 620 on the secondary wire 604A at a print material target fill level 610 of the upper pump 602. Again, the algorithm will use input from the secondary wire feed system 604 motor and encoder to determine the correct length of secondary wire 604A to feed into a pool of molten or liquid print material 608 to accomplish this. During this step, the secondary wire 604A breaks a laser 616 emitted from a pass-through sensor laser emitter 612 towards a pass-through sensor laser detector 614 at wire point “A” 618. Wire length “C” 622 can be determined by calculating a difference between wire point “A” 618 and wire point “B” 620.

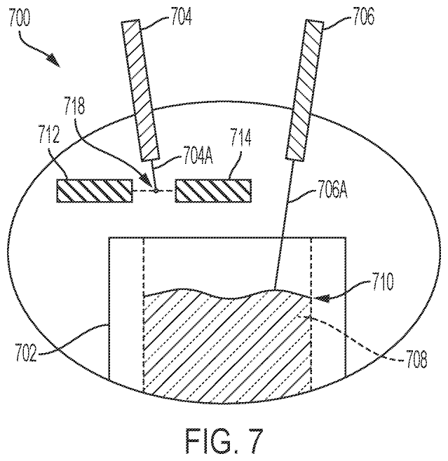

FIG. 7 illustrates a schematic of a portion of a printing system including a level sensing and controlling system in a metal jetting apparatus during a step of the level sensing and controlling process, in accordance with the present disclosure. A view of a portion of a level sensing and controlling system 700 includes a portion of an upper pump 702, a secondary wire feed system 704 having a secondary wire 704A and a primary wire feed system 706 or primary printing material feed system having a primary wire 706A. FIG. 7 illustrates a step for the process for sensing a level in an ejector jet, wherein the secondary wire 704A is retracted until a pass-through sensor laser emitter 712 sending a laser 716 to a pass-through sensor laser detector 714 detects an end of wire point “B” 720 at an end of the secondary wire 704A, resulting in case 1, as described herein. In this case, the result of the retraction shows that the length of the secondary wire 704A has not changed. In other words, an algorithm retained a recorded value of the amount of secondary wire 704A fed out, corresponding to a wire length “C” 722, and when it was retracted, the same wire length “C” 722 was retracted when the laser 716 detected wire point “B” 720 at an end of the secondary wire 704A. In this case, since the length of the wire has not changed it can be determined that the molten or liquid print material 708 is at or below the “maximum” print material target fill level 710 in the upper pump 702.

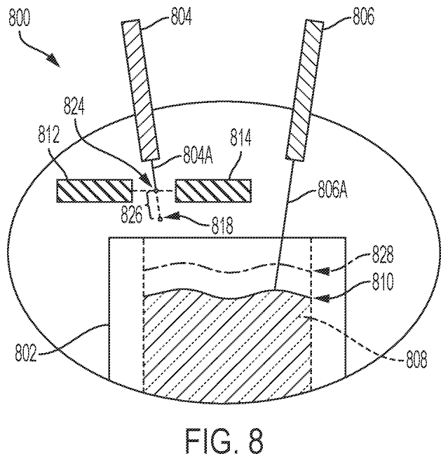

FIG. 8 illustrates a schematic of a portion of a printing system including a level sensing and controlling system in a metal jetting apparatus during a final step of the level sensing and controlling process, in accordance with the present disclosure. A view of a portion of a level sensing and controlling system 800 includes a portion of an upper pump 802, a secondary wire feed system 804 having a secondary wire 804A and a primary wire feed system 806 or primary printing material feed system having a primary wire 806A. FIG. 8 illustrates a step for the process for sensing a level in an ejector jet, wherein the secondary wire 804A is retracted and found to be shorter than the “starting” length, resulting in case 2, as described herein. It is shown that case 2 is encountered when the secondary wire 804A is retracted from the inner cavity of the upper pump 802. In this case, it is determined that the length of the secondary wire 804A returns shorter than its original length. This indicates that the exact height of molten or liquid print material 808 in the upper pump 802 is known relative to the height of a pass-through sensor laser emitter 812 sending a laser 816 to a pass-through sensor laser detector 814 laser detector. The amount of secondary wire 804A which was melted in the in liquid print material 808 in the upper pump 802 is equal to wire point “B” 818 minus wire point “D” 824. In this manner, the secondary wire feed system 804 will feed secondary wire 804A to the laser sensor 812, 814, 816, identify the end location of the secondary wire 804A, advance into the upper pump 802 a known amount, and determine if case 1 or case 2 occurs. If case 1 occurs, the exact location of the top of the fluid surface is not known. Therefore, the next iteration of wire feeding will advance a length “C” plus an additional incremental amount, which will within a set number of iterations will arrive at case 2. Then the actual height of the fluid surface 828 is known and the “open-loop” control for the primary wire feed system 806 feed will be adjusted accordingly. The primary wire feed system 806 will be adjusted incrementally faster if the measured surface height 828 is lower than the print material target fill level 810, and slower if the measured surface height 828 is higher than the print material target fill level 810. By starting at a nominal length, corresponding to the print material target fill level 810 of secondary wire 804A to feed in, and then continuing repeat the process and lengthen that distance until case 2 is encountered the exact height 828 of the molten or liquid print material 808 in the upper pump 802 can be determined. The starting point of the “feed-in” length for the secondary wire feed system 804 will be such that the end of the secondary wire 804A would nominally end at the print material target fill level 810.

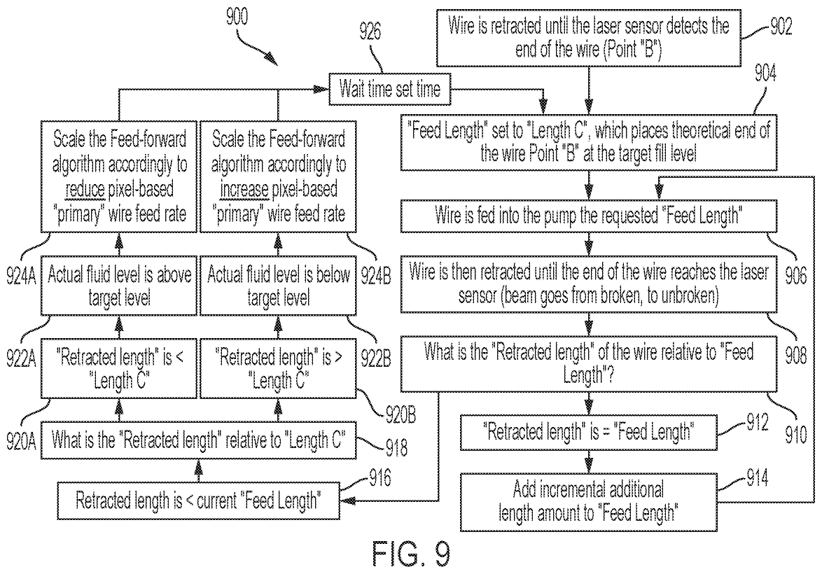

FIG. 9 illustrates a flowchart of several operation steps of a level sensing and controlling system in a metal jetting apparatus, in accordance with the present disclosure. FIG. 9 shows a proposed operation process, exhibiting the various control features of the method and system for level sense and how the system would proceed depending on different liquid pool height scenarios to properly feed-back the necessary scaling adjustments to the feed-forward “primary” wire feed. In this manner, the liquid pool height is more reliably controlled as compared to the current system, which can be interrupted by the presence of contamination on a surface of a melt pool in the inner cavity of the ejector jet. A method of sensing and controlling level in a metal jetting apparatus 900 is illustrated, beginning with a step where a secondary wire is retracted until the laser sensor detects an end of a wire 902 at point “B” to determine the initial length of the secondary wire. Next, a feed length is set to length “C” which places a theoretical end of the wire point “B” at the target fill level 904.

Next, the wire is fed into the pump of the ejector by the requested “feed length” 906, the wire is retracted until the end of the wire reaches the laser sensor 908, the beam exits the laser sensor, or the beam in the laser sensor goes from broken to unbroken, next it is determined what is the “retracted length” of the wire as compared to the “feed length” 910. The “feed length” was determined in step 904. Based on the information determined in the preceding steps, a first decision point is reached. If the retracted length is equal to feed length 912, the system will add an incremental length amount to the “feed length” 914, and steps 906, 908, and 910 are repeated as needed. Following step 910, a second decision point may be reached. If it is found that the retracted length is less than the current “feed length” 916, then it is determined what is the “retracted length” as compared to “length C” 918. If the retracted length is greater than “length C” 920A, then the actual fluid level is below the target level 922A and the feed-forward algorithm of the primary print material feed is increased on a pixel-based feed rate 924A. If it is found that the retracted length is less than “length C” 920B, then the actual fluid level is above the target level 922B; and therefore, the feed-forward algorithm of the primary print material feed is reduced or decreased on a pixel-based rate 924B. Finally, the printer is instructed to wait a set time 926. This predetermined time interval can be from 1 minute to about 10 minutes, or from about 1 minute to about 5 minutes, or from about 1 minute to about 2 minutes. These operation steps of a level sensing and controlling system in a metal jetting apparatus can include advancing a predetermined feed length of a secondary print material comprising a wire into an inner cavity of a metal ejecting apparatus wherein the predetermined feed length corresponds to a target fill level of the inner cavity of the metal ejecting apparatus, detecting a first measurement of an end of the secondary print material, retracting the secondary print material from the inner cavity of the metal ejecting apparatus, detecting a second measurement of an end of the secondary print material, and comparing the first measurement of an end of the secondary print material to a second measurement of an end of the secondary print material to determine a retracted length.

Methods and apparatus for a level sense for a metal ejector jet and printing system in accordance with the present disclosure provide a secondary wire feed input, using the same aluminum alloy or printing material as the primary wire feed input, which can be used as a means of making a positive assessment of the height of the liquid aluminum in the pump. This secondary wire feed input measurement can be utilized periodically to verify the fluid height in the melt pool in an inner cavity of the ejector jet, at a predetermined time, on the order of every couple minutes, or other interval as needed. During the interval between these measurements the machine can rely on a feed-forward control to regulate input wire to the upper pump based on a known drop usage over that time and average drop mass. The second wire feed wire feed input can utilize a pass-through laser sensor which can assess the initial “end-point” of the wire before it is fed into the molten aluminum pool at the top of the pump, and then also re-assess the “end-point” of the wire once it has been removed or retracted from the upper pump. By beginning at a nominal length, corresponding to a target pump fill level, of wire to feed in, and then continuing repeat the process & lengthen that distance until case 2, where the length of the wire is now shortened, is encountered the exact height of the molten aluminum in the pump can be determined. Such a method and system as described herein provides advantageous print run times that can be increased before an un-planned shut-down, which provides a benefit to a printing system by allowing for larger size part builds and increased overall productivity. The method and system further serves to improve the life of the upper pump as dross build up from longer runs can be detrimental to the operation of upper pumps. It is also known that seasoned or used upper pumps have improved sustained jetting performance. The system and methods of level sense can also improve the ability of the printing system to measure and control the level of the melt pool height in the inner cavity of the ejector, and in certain cases, can enable operation at higher pump temperatures for improved jet quality.

Such a printing system and method and apparatus for level sensing can be used instead of or in addition to the existing level detection system. It should be noted that the second feed is not intended to be a material supply, just used as a probing level sense, which can be employed during a printing operation or in between printing operations, i.e., during a pause in printing operations. It is not necessary to stop printing while measuring or performing methods as described herein. As such, while it may be of interest to use a similar wire material in the secondary feed system as the printing material, it does not necessarily need to be the same. Methods as described herein do not rely on laser reflecting off a surface of a melt pool, which can be inhibited by contamination, such as dross. Even if the second feed wire contacts dross at a surface of the melt pool, it will still melt, thereby still enabling an effective level sense and determination.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A printing system, comprising:
a metal ejecting apparatus, comprising:
a structure defining an inner cavity to receive a metal printing material; and
a nozzle orifice in connection with the inner cavity and configured to eject one or more droplets of a liquid metal comprising the metal printing material;
a first print material feed system configured to supply a first print material into the inner cavity; and
a second print material feed system comprising a second print material configured to measure a level of metal printing material in the inner cavity, wherein the second print material is a wire.

2. The printing system of claim 1, further comprising a pass-through laser sensor, wherein the second print material is detected by the pass-through laser sensor.

3. The printing system of claim 1, wherein the first print material comprises a wire.

4. The printing system of claim 1, wherein the first print material and the second print material comprise the same composition.

5. The printing system of claim 1, wherein the first print material comprises aluminum.

6. A method of sensing and controlling level in a metal jetting apparatus, comprising:
advancing a predetermined feed length of a secondary print material comprising a wire into an inner cavity of a metal ejecting apparatus wherein the predetermined feed length corresponds to a target fill level of the inner cavity of the metal ejecting apparatus;
detecting a first measurement of an end of the secondary print material;
retracting the secondary print material from the inner cavity of the metal ejecting apparatus;
detecting a second measurement of an end of the secondary print material; and
comparing the first measurement of an end of the secondary print material to a second measurement of an end of the secondary print material to determine a retracted length.

7. The method of sensing and controlling level in a metal jetting apparatus of claim 6, further comprising repeating the steps of advancing the predetermined feed length of the secondary print material into the inner cavity of the metal ejecting apparatus, detecting the first measurement of the end of the secondary print material, retracting the secondary print material from the inner cavity of the metal ejecting apparatus, detecting the second measurement of the end of the secondary print material, and comparing the first measurement of the end of the secondary print material to the second measurement of the end of the secondary print material to determine a retracted length.

8. The method of sensing and controlling level in a metal jetting apparatus of claim 6, further comprising pausing after advancing the predetermined feed length of the secondary print material.

9. The method of sensing and controlling level in a metal jetting apparatus of claim 6, further comprising waiting a predetermined time prior to advancing the predetermined feed length of the secondary print material.

10. The method of sensing and controlling level in a metal jetting apparatus of claim 6, further comprising increasing the predetermined feed length of the secondary print material if the retracted length is less than or equal to the predetermined feed length of the secondary print material.

11. The method of sensing and controlling level in a metal jetting apparatus of claim 6, further comprising decreasing the predetermined feed length of the secondary print material is greater than the retracted length of the secondary print material.

12. The method of sensing and controlling level in a metal jetting apparatus of claim 6, further comprising adjusting a target fill level of a primary print material in the inner cavity of the metal ejecting apparatus.

13. The method of sensing and controlling level in a metal jetting apparatus of claim 12, wherein the target fill level of the primary print material is increased when the predetermined feed length of the secondary print material is less than the retracted length of the secondary print material.

14. The method of sensing and controlling level in a metal jetting apparatus of claim 12, wherein the target fill level of the primary print material is decreased the predetermined feed length of the secondary print material is greater than the retracted length of the secondary print material.

15. The method of sensing and controlling level in a metal jetting apparatus of claim 12, wherein the primary print material and the secondary print material comprise the same composition.

16. A method of sensing and controlling level in a metal jetting apparatus, comprising:
advancing a predetermined feed length of a secondary print material comprising a wire into an inner cavity of a metal ejecting apparatus at a pixel-based feed rate of a primary print material;
detecting a first measurement of an end of the secondary print material;
retracting the secondary print material from the inner cavity of the metal ejecting apparatus;
detecting a second measurement of an end of the secondary print material; and
comparing the first measurement of an end of the secondary print material to a second measurement of an end of the secondary print material to determine a retracted length.

17. The method of sensing and controlling level in a metal jetting apparatus of claim 16, further comprising adjusting a fill level of the inner cavity of the metal jetting apparatus.

18. The method of sensing and controlling level in a metal jetting apparatus of claim 16, wherein the pixel-based feed rate of the primary print material is increased when the retracted length is greater than the predetermined feed length.

19. The method of sensing and controlling level in a metal jetting apparatus of claim 16, wherein the pixel-based feed rate of the primary print material is decreased when the retracted length is less than the predetermined feed length.

20. The method of sensing and controlling level in a metal jetting apparatus of claim 16, wherein the primary print material and the secondary print material comprise the same composition.
